(19) United States
(12) Patent Application Publication
(10) Pub. No.: US 2007/0238481 A1
(43) Pub. Date: Oct. 11, 2007

(54) Self-Adhesive Remote-Control Keyboard for a Portable Cellular Telephone

(76) Inventor: Jacques Gaucherot, Cherbourg (FR)

Correspondence Address: MOETTELI & ASSOCIATES SARL, ST. LEONHARDSTRASSE 4, ST. GALLEN, CH-9000, CH

(21) Appl. No.: 11/575,309

(22) PCT Filed: Aug. 30, 2005
(86) PCT No.: PCT/FR05/02168

§ 371 Date: Mar. 15, 2007

(30) Foreign Application Priority Data
Sep. 16, 2004 (FR) 0409842

(51) Int. Cl. H04M 1/00

(52) U.S. Cl. 455/550.1

(57) ABSTRACT

The inventive self-adhesive and sealed device having a deformable structure enables, for example, a skier provided with a portable cellular telephone (a) connected to a transmission/reception interface (b) and to an earphone/microphone set (c) to transmit or receive telephone calls without taking off his gloves and without handling the portable telephone thereof. The keyboard is fixable to a support (a vehicle panel board, a motorcycle tank, clothes, on a flat part of ski) by means of an adhesive element (1) disposed on the lower face of a flexible pad (2). The pad is sealingly covered by an elastic shell (3) which comprises large keys (4) and a transparent window on the external face thereof. The sealed chamber which is formed by the pad and shell contains a battery, an electronic system for transmitting and receiving signals allocated to the interface of the portable telephone of a user and electric connections for said components. The anti-thief device of the keyboard is intrinsic in such a way that the keyboard is useless without the interface associated to the portable telephone.

### BACKGROUND OF THE INVENTION

The present invention concerns a device that makes it possible to carry out remote actions required for sending or receiving a telephonic communication by means of a mobile cell phone having an send/receive interface adapted to that device.

Taking into account the state of the art in the field of telephony, including that for vocal commands, in a large majority of cases, when a mobile cell phone user receives a call or when he makes a call, it is necessary for him to activate a certain number of keys on the keypad of that said mobile. These actions, insignificant in everyday life, quickly become uncomfortable when the user is gloved, and is more so if he is in a restrictive or harsh environment. For example, a ski track, strictly speaking is not a harsh environment for the user but the mobiles are hardly able to withstand humidity, shocks and cold. The user also does not like to remove his skiing gloves or his mittens, to open a pocket or a part of his clothes or to expose his hands to the cold. As per this example, receipt of a call is frequently synonymous with constraints, lack of time and discomfort. Miniaturization of mobile phones is appreciated in everyday life, but the above situation, although marginal, suffers from it. Above all, the mobile phone user in a ski resort seeks an environment of leisure and not of constraints; besides, the prevalent technical provisions lack comfort. Moreover, because of their reduced size, the mobile phones do not offer a surface conducive to the inscription of advertising messages.

Generally, the remote control casings, under wider meaning of the context, lack typical features: signal reception, waterproofing, elastic distortion, and a self-sticking fixation mode, as are necessary in the given context.

What is needed therefore is a means of inputting information into a mobile phone without, at the same time, having to deal with the negative consequences of miniaturization.

Still further, what is needed, is a means which permits user interaction with a mobile phones, while not exposing the mobile phone to adverse elements and to minimize the likelihood of damage thereto due to use during fast-moving or shock-intensive sports.

### SUMMARY OF THE INVENTION

The keyboard described hereafter affixes to an object in a convenient location to the user, while allowing the user, in the given example, to protect his mobile phone by covering it inside his clothes. Also, for protection purposes and in line with the given example, a skier's head is generally covered with a helmet or a hat, and wears a pair of goggles or a mask. In order to communicate, in a further feature of the invention, the user will complement the above-mentioned equipment with an earflap and a microphone. This earflap/microphone is connected, with or without a cord, to the mobile cell phone which itself is connected, with or without a cord, to a suitable send/receive interface, indeed exclusively dedicated to the present device. In view of this context, the keypad, according to the invention, makes it possible to correct the abovementioned constraints and inconveniences.

### BRIEF DESCRIPTION OF THE DRAWINGS

The attached drawings illustrate the invention:

FIG. 1 shows the device of invention, section AA.

FIG. 2 shows a top view of the invention (dummy stoppages not shown).

FIG. 3 shows a variation of the device of invention, section AA.

FIG. 4 shows a cutaway view of the device of invention.

FIG. 5 shows an electrical diagram of the invention.

### DETAILED DESCRIPTION OF THE PREFERRED EMBODIMENT(S)

The inventive self-adhesive and sealed device has a deformable structure enables, for example a skier provided with a portable cellular telephone (a) connected to a transmission/reception interface (b) and to an earphone/microphone set (c) to transmit or receive telephone calls without taking off his gloves and without handling the portable telephone thereof. Said inventive keyboard is fixable to a support (a vehicle panel board, a motorcycle tank, clothes, on a flat part of ski) by means of an adhesive element (1) disposed on the lower face of a flexible pad (2). Said pad is sealingly covered by an elastic shell (3) which comprises large keys (4) and a transparent window on the external face thereof. The sealed chamber which is formed by the pad and shell contains a battery, an electronic system for transmitting and receiving signals allocated to the interface of the portable telephone of a user and electric connections for said components. The anti-thief device of the keyboard is intrinsic in such a way that the keyboard is useless without the interface associated to the portable telephone.

In fact, per its initial feature, this keypad comprises a sealed cavity made of flexible, soft and waterproof materials assembled by welding, gluing or any other technique that will guarantee that water tightness of the said joining. As an example, the waterproofing capacity for this keypad is preserved during an immersion under four or five meters of water. This containment cavity is fixed on a flat part of a ski, a snowboard or on any other support, by means of an adhesive substance. In this document, the part of this cavity making the most contact with the support is called a base plate, and the part opposite to the base plate is called a cover. The adhesive substance used for fastening the device on a support is adhered to the lower face of the cover during manufacturing of the keypad. This method of fixation is similar to that of a self-adhesive sticker, which first requires removal of a protective film from the adhesive substance.

The cover is equipped with predetermined zones that, according to their shapes or the affixed marks, constitute the keys of the aforementioned keypad. At minimum, there are twelve keys, ten of which are numbered from zero to nine. The two remaining balance keys are respectively identified according to a start/stop markup such as, for example: on/off or green/red colour. These keys carry alphabetical inscriptions and/or reference marks. Size, shape, transparency, retroluminescence of the materials as well as the position of these keys are adapted to a digital pressure applied by a user, who could be wearing thick gloves. Each key is of a significant size so as to facilitate reading of the inscriptions on these keys from a distance, and is placed to facilitate proper positioning of the user's finger. One or several zones of the cover are transparent or translucent. These zones can be made of a semi-rigid material integrated into the cover or in a rigid material affixed on the envelope.

Internal volume of the containment cavity comprising the space between the base plate and the cover is used to shelter and to protect the electrical and electronic components of this keypad. These electrical and electronic components are retained by means of fixing mastic on the upper part of the base plate. These components are: a source of electrical power from lithium type or electrochemical type battery one or several electroluminescent diodes, electrical conductors as well as an electronic transceiver module dedicated to a send/receiver interface linked or connected to electronics of a mobile cell phone. The electrical conductors ensure that link between the electrical circuit parts located in relation to the predetermined zones of the cover, called keys and the abovementioned internal components as well as between the said components themselves. Applying pressure on one of these keys modifies the electrical status of the part of the electrical conductor located as per the pressed key and thus the electrical circuit of the components associated with this circuit. The electronic receive/send module is composed of an electronic circuit comprising integrated circuits of a transmitter and a receiver of electromagnetic waves belonging to the spectrum of radio frequencies. This electronic receive/send module is calibrated in order to generate signals of a frequency and for a different structure for each key on the pressed keypad. The receive/send electronics of this module is calibrated to generate or capture signals on a short distance, about three meters and according to an angle of selected or multidirectional emission or reception. The axis and also the active parts of these transducers are of an orientation suitable for the configuration of usage and, thus, in relation with the space between the support receiving this keypad and the location, considered preferential, of the send/receive interface associated with the mobile cell phone of the user. The axis of transducers used are oriented towards send/receive elements of the abovementioned interface, generally towards the user when he presses keys of the said keypad while being in the conventional position of reading the inscriptions given on the latter. Thus, when the user presses or brushes a key on the keypad under invention, he emits specific radio electrical waves, which, once processed by the electronics associated with the receiving interface of the mobile cell phone of the user, makes it possible to control the said mobile and to cause an action directly on the key of this mobile corresponding to that of the pressed key. The user is alerted to a telephonic call by sound or vibratory functions of his mobile as well as by lighting one or several electroluminescent signal diodes located within the keypad under invention. Lighting, possible blinking, from this or these diode(s) is initiated by the signals released by the electronics associate with the emitting interface of the said mobile. These signals are then captured by the transducer integrated with the electronic module of reception of the keypad under invention, then processed by the latter, in order to establish the electrical circuit making it possible to feed this or these call signal diode(s).

Internal volume of the containment cavity is partially or totally filled by a compound made from a resin, gel or mastic or alveolar material base. The objective of this partial or total filling is to enable an optimization of elasticity of the complete keypad. In fact, considering the context of usage for this keypad, it could become covered with ice. In case of a thin ice layer, the latter would be much easier to break up and thus remove, if it is deposited on a flexible and elastic support to the point of being easily malleable. For example, this distortion can be obtained by a digital pressure applied perpendicular to the upper face of the cover or laterally on a part of the body of this keypad. The elasticity of this keypad will thus be optimized during its fabrication between, on the one hand, a flexible cavity comprising an internal volume filled with air, whose thickness and structure of cover ensure its maintenance, and on the other hand, an internal volume gradually filled with the abovementioned compound according to the intended elasticity. In the latter case, the cavity, that is, the base plate and/or the cover as well as the internal volume, can be partially or totally made up of the said compound. Always taking into account this context, the outer forms of the cover will be flat, rounded, sloping and smooth, in order to limit fluid retention, particularly snow and possibly ice. Different keyboard designs and particularly those of the cover can be molded or pre-formed. The choice of designs retained for production of this keyboard, such as, for example, number and size of the points of support, will contribute to optimization of its elastic amplitude. This filling compound is also used to complement the maintenance of the abovementioned electrical and electronic components and more so to ensure their fixation when using forms making it possible to mould these components from a casting.

As per specific modes for execution of the invention:

The adhesive substance, which enables fastening the keypad under invention on a support, can be applied on one or some visible parts of the cover with support or on any other parts associated with the cover such as an adhesive tape.

Fastening of keypad under invention on a support can be completed by a stitch or by a weld joining the support to zones of the base plate and/or the cover.

the cavity of the keypad under invention, whose base plate and cover as well as internal volume and its associated components, can in most cases be very thin. Thus, this unit appears, more often than not, in the form of a sticker such as that used during advertising campaigns.

The source of electrical power for the keypad under invention may be, partly or entirely, provided by a photovoltaic solar cell whose sensor can be located under a transparent part of the cover. This sensor can also be located on an external face of the cover. In that case, this source of power would be in addition to a cell or a battery, the electrical connection with the electrical circuit implanted in the cavity would be realized at the ends of electrical circuit connect to the said cell or batter. In case of connections, out of the cavity, the integrity of waterproofing of this cavity would be preserved by resin based waterproofing or mastic provided in the zone linking the said connection to the cavity.

The source of power of the keypad under invention can be located outside of the abovementioned sealed cavity. The ends of the electrical circuit conductors connected to the electrical source in this case would also be located outside the cavity. In order to preserve the integrity of waterproofing of this cavity a resin or mastic would be provided in the zone linking the said connection to the cavity.

The electroluminescent diode to signal a telephonic call from the keypad under invention can be located out of sealed cavity. The connection with internal volume of the said cavity would then be sealed by means of a resin or mastic in order to preserve integrity of waterproofing of this cavity.

With the objective of providing a very economical performance of the keypad under invention, the electroluminescent diode(s) for signalling used to alert the user of a telephonic call, as well as the electronic associated with the latter, can be discarded.

With the objective to exclusively dedicate the emitting and/or reception of signals handled by the electronic module of the keypad under invention, this module and particularly the integrated circuits of the component, can be equipped with micro-programmers that allow for the coding and decoding of the signals exchanged with the interface of emission/reception associated with the mobile cell phone of the user. These micro-programmers can be implanted in the cavity so that the action of parametering of these micro-programmers is available only before gluing of the keypad under invention on a support. In this case, the base plate can be procured locally from a predetermined zone, of minimal thickness or likely to receive a screen, for example metallic and/or mastic for waterproofing.

With the objective to better inform the user, the composition of numbering demonstrated on the keypad under invention can feed a unit of electroluminescent diodes whose lighting from one or many of these diodes would keep the user informed of the level of reception from the receiver of the said keypad or from that if his mobile cell phone or from the status of the electrical source of the said keypad. The electronic circuit of this keypad would be provided with integrated circuits suitable for these functions and more particularly to command the number of supplied diodes.

With the objective to better inform the user, the composition of numbering demonstrated on the keypad under invention, a liquid crystal alphanumerical display would be implanted under a transparent part of the cover of keypad under invention. The signals captured by the module of emission and reception of the said keypad would then be decoded by an electronic circuit equipped with integrated circuits suitable for the controlling of this display.

With the objective to promote a brand, for example that of a telephonic operator, the upper face of the cover of the keypad under invention can carry one or some representative inscriptions of the said brand.

In addition, description of the context for usage of keypad under invention can be displayed by an emission/reception interface, linked or connected to the mobile call phone of the user, composed of: an emitting interface, a reception interface and a transfer interface. The latter makes it possible to establish electrical connections between the electronic circuit of the mobile cell phone an the electrical information emitted by emission and reception interfaces, mentioned earlier.

The emission interface enables the generation of a signal suitable for the keypad receiver under invention from electrical impulses coming from the mobile telephone via a transfer interface. The reception interface permits the generation, from the signals emitted by the keypad under invention and via transfer interface, of electrical impulses on the mobile telephone. These emitting and receiving interfaces can be associated with the transfer interface or be disassociated from it. These emitting and receiving interfaces can be connected to the transfer interface by an electrical wire connection or connected to it by a connection known as wireless.

In case of an interface combining the emitting/receiving/transfer functions, it can be implanted inside the said mobile cell phone, connected to it by a rigid connector or by an electrical wire connection or connected to it by a connection known as wireless. In addition, microphone as well as the loud speaker(s) enabling a connection by means of the user's mobile cell phone can represent description of the context for usage of keypad under invention. These components can be in the form of a set of earflap, a headphone, and a jacket microphone. These components can be integrated with the protective helmet of the user or in the interior of a vehicle. The connection between these audio components and the said cell phone is of wire or wireless type.

The device under invention is meant to be used principally by a skier. However, this keypad offers advantages in situations where a gloved individual moving in an environment non conducive to the easy handling of a mobile cell phone, while needing it or having time, to communicate by means of the said mobile. The support from the said keypad is in this case diversified. This can be, for example, above the fuel tank of a motorcycle for a motorcyclist or between legs of trousers at the thigh level for a fireman. In view of basic actions necessary for a telephonic communication and taking into account the practical aspect of low cost of the keypad under invention, this device may have a broad range of applications. For example, this keypad, once affixed on the dashboard of an automobile or on that of a scooter, simplifies and secures keys capturing.

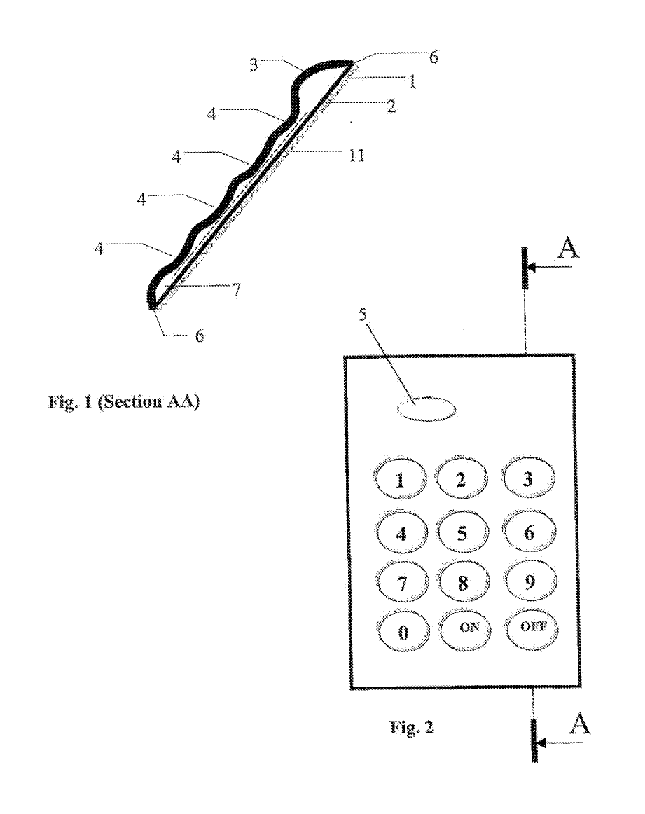

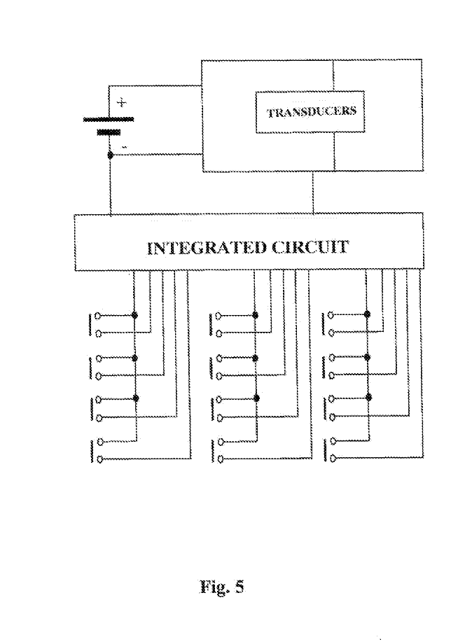

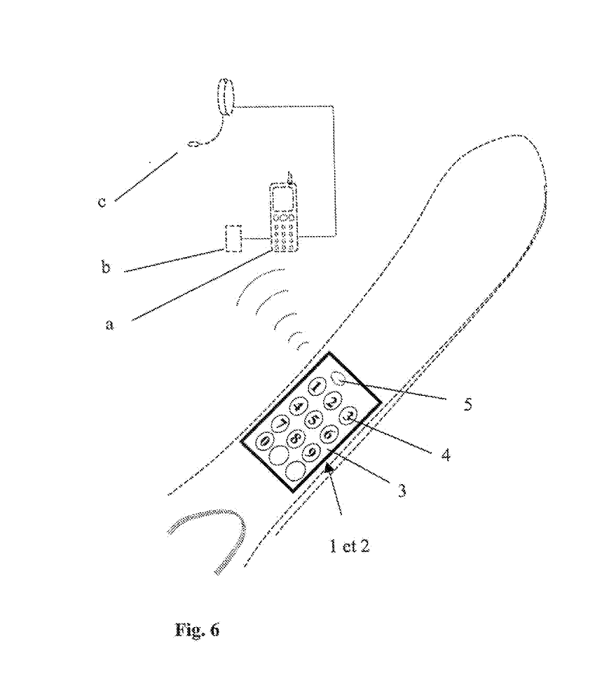

With reference to the drawings and according to a mode of realization, non limiting, corresponding to FIGS. 1, 2, 4 and 5, the device comprises an adhesive substance 1, for example—a double face adhesive, applied on one of the faces of the flexible base plate 2, produced, as an example, by a thin rectangular plate of plastic material. This base plate 2 is covered, on its face opposite to that containing the adhesive substance, of a cover 3, produced with a soft material, for example—a rubber based material.

This cover 3 comprises, on its external face, alphanumerical inscriptions, in zones of same size, called keys 4 and whose number is, for example, twelve. For ten of these keys 4 a figure from zero to nine is written on each one of them. For two of these keys 4, as example, <<ON>> on one and <<OFF>> on the other, is written. Size of these keys 4 is compatible with the event of being pressed by a user who could be wearing thick gloves. According to this mode of realization, these keys 4 are provided equidistant from one another. This cover also comprises a translucent zone 5 produced according to this production method, in the material block of the cover 3 and located in a zone separate from the zone of keys 4. The external surface of this cover 3 is of a weak ruggedness and is composed of rounded shapes.

This cover 3 is, in its thicknesses as in its shapes, structured so as to enable, once the latter is placed on the base plate 2, the assignment of empty spaces between its internal face and the base plate 2. This cover is, as an example, obtained by grinding. According to this production method, the joint 6 enabling association of the cover 3 with the base plate 2 is ensured by a peripheral gluing to the base plate 2. This base plate unit 2 and cover 3 constitutes a containment cavity for waterproof whose internal volume 7 is made up of the spaces left empty between the base plate 2 and the cover 3.

Prior to gluing of cover 3 on the base plate 2 the internal components of this device are fastened on the face of base plate 2, opposite to that provided for adhesive substance 1, by means of a mastic for fixation. Installation of these components on the base plate 2 corresponds to the abovementioned empty spaces. According to this mode of realization, these internal components are composed of an electronic module 8 for transmitting and receiving radio electrical waves, a thin lithium battery 10 and a circuit for electrical conductors 11 composed of a soft film. According to this production mode, the electronic module 8 is composed of an integrated circuit, of transmission/reception transducers, and an electroluminescent diode 9. This diode is implanted under the translucent zone 5 of the cover 3.

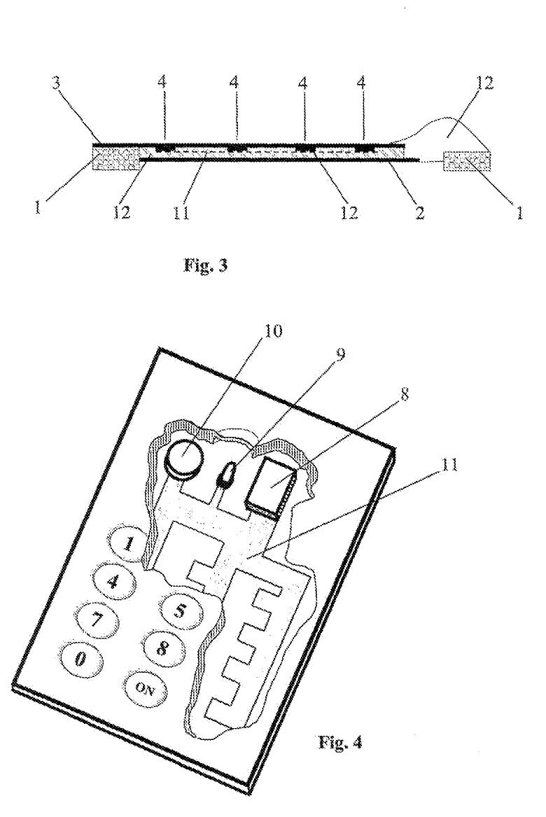

FIG. 3 shows a variation of a production mode, non limiting, of the structure of this keypad. The adhesive substance 1 is partly provided on a part of the cover 3 opposite the mounting bracket the said device. The volume 7 is filled in different ways, it is partly filled with a compound 12 in resin form, which can solidify the cover 3 with the base plate 2 by taking in sandwich a part of electrical circuit 11, it is partly filled with a compound 12 in patch form of alveolar foam opposite each key and it is partly composed of a compound 12 in the form of mastic with elastomer base in the zone of implantation of the electronic module 8 comprising the electroluminescent diode 9, battery 10 and remaining part of the electrical circuit 11. The compound, 12 composed of an elastomer mastic ensures, partially by it, the base plate functions 2, and the cover 3. According to this model variation, the points for fixing the device on a support, that is, the gluing zones 1, allow removing the base plate 2 from the said support with the objective to optimize elasticity of the device unit.

What is claimed is:

1. Device capable of executing remote actions necessary for emitting or receiving a telephonic communication by means of mobile cell phone characterized by the fact that it comprises an adhesive substance (1) disposed on the lower face of a flexible base plate (2) whose upper face is covered with a soft cover (3) which comprises, on its external face, the pre-determined zones of sizable dimensions called keys (4) as well as one or several translucent or transparent zones (5) and whose connections(s) (6) with the flexible base plate (2) make it possible to obtain a waterproof cavity for volume containment (7) so created between the base plate (2) and the cover (3) and within which an electronic module (8) for emission and reception of electromagnetic waves within the spectrum of radio frequencies and one or several electroluminescent diodes (9) are positioned.

2. Device, according to claim 1, wherein radio-electrical signals emitted or received by the electronic module (8) dedicated, exclusively or non exclusively due to a coding at the emission/reception interface linked or connected to the mobile cell phone of the user.

3. Device, according to claim 1 wherein each pressed key (4) generates, via an electrical circuit 11), the source of energy (10) and the electronic module (8), of radio-electrical signals of a frequency and a different structure.

4. Device, according to claim 1 wherein for a sequence of pressed keys (4) or for a radio-electrical signal captured by electronic module (8), the said module (8) establishes an electrical circuit (11) capable of feeding by the intermediary of a electrical energy source (10), the receivers such as one or several electroluminescent diodes for signalling or a liquid crystal alphanumerical display.

5. Device, according to claim 1 wherein the base plate (2), the cover (3) as also is the volume (7) are, complete or partially, composed of a compound (12) with a resin base, a gel, a mastic or a alveolar material, with the objective to promote an optimization of elasticity of the device unit by filling of the volume (7), in order to ensure maintenance, protection and waterproofing of internal components (8, 9, 10, 11).

6. Device, according to claim 1, wherein the pre-determined zones called keys (4) are adapted to a digital pressure applied by a user wearing thick gloves, at least twelve in number, ten of which are numbered from zero to nine, this digital inscription is possible accompanied by alphabetic marks and two to these keys are respectively identified by a start/stop markup.

7. Device, according to claim 1, wherein the adhesive substance (1) is located on the parts of the cover (3) relative to the support on which the base plate (2) is affixed or on all other parts associated with the cover (3) such as an adhesive tape.

8. Device, according to claim 1, wherein the fastening of said device on a support held by a stitch or a weld, linking the support to the base plate (2) and/or to the cover (3).

9. Device, according to claim 1, wherein the source of electrical energy (10) is, entirely or partly, produced by one photovoltaic solar cell whose receiver is located under a transparent portion (5) of the cover (3) or on the external face of this cover (3).

10. Device, according to claim 1, wherein the source of electrical energy (10) and the ends of electrical circuit conductors (11) linked to the electrical source (10) are located outside of the cavity delimiting the volume (7).

11. Device, according to claim 2, wherein each pressed key (4) generates, via an electrical circuit (11), the source of energy (10) and the electronic module (8), of radio-electrical signals of a frequency and a different structure.

12. Device, according to claim 2 wherein for a sequence of pressed keys (4) or for a radio-electrical signal captured by electronic module (8), the said module (8) establishes an electrical circuit (11) capable of feeding by the intermediary of a electrical energy source (10), the receivers such as one or several electroluminescent diodes for signalling or a liquid crystal alphanumerical display.
